(19) United States
(12) Patent Application Publication
(10) Pub. No.: US 2026/0245125 A1
(43) Pub. Date: Aug. 20, 2026

(54) SOFTWARE PLATFORM WITH ARTIFICIAL INTELLIGENCE (AI) INTERFACE FOR GENERATING CONTRACTOR ESTIMATES

(71) Applicant: Blue Collar Ai LLC, Dover, DE (US)

(72) Inventors: Trent Lavoie, Mountain View, CA (US); Emanuel Jimenez, JR., East Palo Alto, CA (US)

(21) Appl. No.: 19/059,062

(22) Filed: Feb. 20, 2025

(51) Int. Cl. G06Q 30/0601

(52) U.S. Cl. CPC G06Q 30/0611

(57) ABSTRACT

Embodiments are described of an apparatus including a server communicatively coupled to a network. At least one software module runs on the server, and the at least one software module includes instructions that, when executed by the server, cause the server to receive input information input by a technician into a technician device communicatively coupled to the network. The input information is relevant to a product or a service that the technician has identified to solve a problem presented to the technician by a customer. The at least one software module also looks up supplemental information about the problem, the product, or the service, and aggregates the input information and the supplemental information into an aggregated artificial intelligence (AI) prompt.

### TECHNICAL FIELD

The disclosed embodiments relate generally to preparation of contractor estimates and in particular, but not exclusively, to an apparatus and system by which a contractor can use an artificial intelligence (AI) system to generate AI-enhanced estimates.

### BACKGROUND

In many service businesses it is common, before providing a service, for the business or one of its representatives to meet with the customer, assess the customer's needs, and present a proposal for the products and services needed to address the customer's needs. This proposal can also be referred to as a sales quote, since it typically quotes a price for the products and services being sold to the customer. Many of the construction trades—carpenters, electricians, plumbers, roofers, heating and air-conditioning (HVAC), and so on—operate this way.

In a typical construction-trade scenario, the customer calls a contractor and arranges to have a technician visit their site—i.e., the job site, which can be a home, a business, or another physical facility—to assess the customer's needs. The technician visits the job site, looks at the situation, and provides a recommendation that they think will address the customer's needs. Using a plumbing contractor as an example, for instance, a customer might call a plumbing contractor to report a problem with their hot water heater. The plumbing contractor dispatches a technician (i.e., a plumber) to examine the water heater. After examination, the plumber might recommend fixing the existing water heater, replacing it with a new one of the same kind, or replacing it with something different.

But a few factors can limit the plumber's recommendations. First, a plumber cannot be expected to know every, or even most, possible solutions to a given problem—that is, they can't be expected to have complete or extensive knowledge of products and services that can address the customer's needs. Second, product prices change constantly, so that at any given time a plumber cannot be expected to know the cost of every available option. Finally, the plumber's recommendations can be influenced by their knowledge and experience; they can tend to always recommend what they're familiar with, even if better solutions might be available. Beyond the recommendations themselves, the plumber might not be able close the sale by explaining to the customer the pros and cons of their recommendations, or providing or explaining the associated costs, schedule, and other factors. That can limit the contractor's business.

### SUMMARY

In one aspect, an apparatus comprises a server communicatively coupled to a network. At least one software module runs on the server, and the at least one software module includes instructions that, when executed by the server, cause the server to receive input information input by a technician into a technician device communicatively coupled to the network. The input information is relevant to a product or a service that the technician has identified to solve a problem presented to the technician by a customer. The at least one software module also looks up supplemental information about the problem, the product, or the service, and aggregates the input information and the supplemental information into an aggregated artificial intelligence (AI) prompt.

In another aspect, a system comprises an estimator server communicatively coupled to a network. At least one software module runs on the estimator server, and the at least one software module includes one or more application programming interfaces that allow the estimator server to interact, via the network, with a contractor server and an artificial intelligence (AI) server. The at least one software module including instructions that, when executed by the estimator server, cause the estimator server to receive input information input by a technician into a technician device communicatively coupled to the network. The input information is relevant to a product or a service that the technician has identified to solve a problem presented to the technician by a customer. The at least one software module also looks up supplemental information about the problem, the product, or the service, and aggregates the input information and the supplemental information into an aggregated artificial intelligence (AI) prompt. The at least one software module can then transmit the aggregated AI prompt to an AI engine on the AI server for processing into an AI sales quote, and receive the AI sales quote and transmit it to the contractor server.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a flowchart of an embodiment of a process used by a contractor for estimating, proposing, and performing a contracting job.

FIG. 2 is a diagram of an embodiment of a system by which a contractor can use artificial intelligence (AI) to enhance and improve the preparation of a proposal or sales quote for a contracting job.

FIG. 3 is a flowchart of an embodiment of a process used by a contractor for estimating, proposing, and performing a contracting job using a system such as the one shown in FIG. 2.

FIG. 4 is a flowchart of an embodiment of a process used by an estimator module in a system such as the one shown in FIG. 2 to receive input from a technician.

FIGS. 5A-5B are flowcharts of an embodiment of a process by which an estimator module in a system such as the one shown in FIG. 2 can supplement input provided by a technician.

FIG. 6 is a flowchart of an embodiment of a process by which an estimator module in a system such as the one shown in FIG. 2 assembles information provided by a technician and supplemental input found by the estimator into an artificial intelligence (AI) prompt for a proposal or sales quote.

FIG. 7 is a flowchart of an embodiment of a process by which an AI-enhanced proposal or sales quote can be reviewed and revised by a user and provided to a customer.

FIG. 8 is a flowchart of an embodiment of a process by which a user can create AI-enhanced follow-up communication after a proposal or sales quote has been provided to a customer.

### DETAILED DESCRIPTION

Embodiments are described of an apparatus, system and method by which a contractor can use an artificial intelligence (AI) system to generate AI-enhanced sales quotes (i.e., work proposals). Specific details are described to provide an understanding of the embodiments, but one skilled in the relevant art will recognize that the invention can be practiced without one or more of the described details or with other methods, components, materials, etc. In some instances, well-known structures, materials, or operations are not shown or described in detail but are nonetheless encompassed within the scope of the invention.

Reference throughout this specification to “one embodiment” or “an embodiment” means that a described feature, structure, or characteristic can be included in at least one described embodiment, so that appearances of “in one embodiment” or “in an embodiment” do not necessarily all refer to the same embodiment. Furthermore, the particular features, structures, or characteristics may be combined in any suitable manner in one or more embodiments.

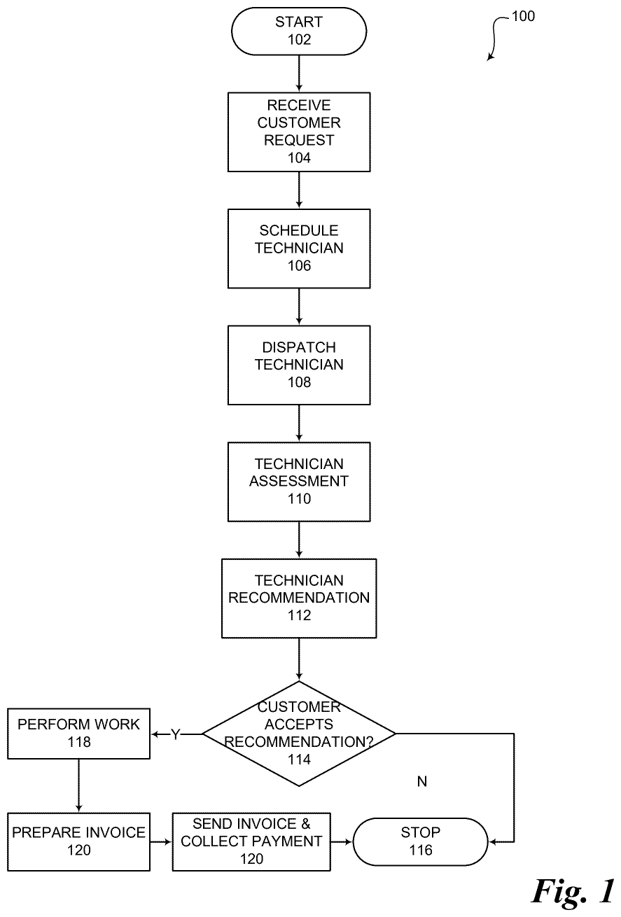

FIG. 1 illustrates, in flowchart form, a process 100 by which a contractor estimates, proposes, and performs work for a customer. The process starts at block 102. At block 104, the contractor receives a request from a customer. Depending on the type of contractor, customer requests can be requests to service something the customer already has (i.e., repair, replace, or remove an existing arrangement) or requests to provide or create something the customer doesn't already have (e.g., construction, installation, and set-up of a new arrangement), but of course customer requests are not limited to these options and can be for something else entirely. If the contractor is a plumber, for instance, a customer can request repair or replacement of a water heater or installation and set-up of a new sink with a garbage disposal. At block 106 the contractor, in consultation with the customer, schedules a date and time for a technician to visit the job site, which is usually the customer's facility. At block 108, when the agreed time and date comes, the contractor dispatches one or more technicians to the job site to evaluate what products and services, and how much of each, the job will entail.

At block 110, the technician assesses the situation at the job site. If the customer described a problem but not its cause, then the technician's assessment can include a diagnosis of the problem; if the customer already knows the cause, then the technician would normally want to confirm the customer's diagnosis before proceeding. Having assessed or diagnosed the situation at block 110, at block 112 the technician provides a proposal for the work required for the job; this proposal can also be referred to a sales quote, since the contractor is essentially selling products and services to the customer to accomplish the job. Often the technician first delivers the sales quote to the customer orally, then follows up later with a written sales quote. But the technician's recommendations can be limited. They might have little experience with the exact problem at hand, and thus might not be able to recommend a good or optimum solution. And even if the problem at hand is one the technician has solved before, even the best technician won't be aware of all available solutions. which one is the best match for the situation, and how to implement it. That's where AI can help, as further discussed below.

At block 114 the customer, having considered the technician's recommendation, decides whether to accept the recommendation and proceed with the proposed products and services. If at block 114 the customer does not accept, the process moves to block 116, where it stops. But if at block 114 the customer accepts, then the process advances to block 118, where the contractor delivers the products and performs the services, and then to block 120, where an invoice is prepared, and to block 122where the contractor sends the invoice to the customer and collects payment. The process then stops at block 116.

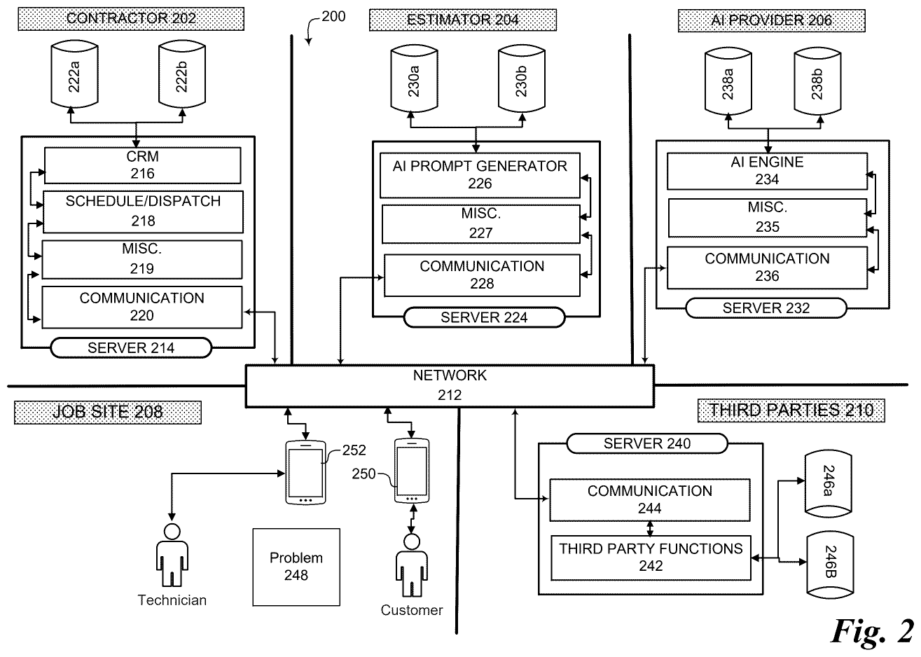

FIG. 2 illustrates an embodiment of a system 200 that a contractor can use to provide enhanced sales quotes. Among other things, sales quotes created using system 200 can be better-written, and written in the customer's own language; can be more accurate; and can present a wider range of repair, replacement, or new construction options to the customer than the technician in process 100.

System 200 involves at least four participants or locations: a contractor 202, an estimator 204, an artificial intelligence (AI) provider 206, and a customer 208. Optional third parties 210 can be included in some embodiments. All four participants are connected to network 212, and can communicate among themselves through the network. In various embodiments, the network connections can be wired connections, wireless connections, or some combination of wired and wireless connections. Although the drawing shows network 212 as a single network, in other embodiments network 212 can actually include multiple networks (i.e., it can be a network of networks) including networks such as the Internet, wide-area networks (WANs), local-area networks (LANs), dedicated connections, and so on. Network 202 can also include networks that are accessible to some participants but not all. For instance, to ensure minimum network lags network 212 can include a dedicated high-speed connection between estimator 204 and AI provider 206 to which only those two participants have access. Network 212 also need not be limited to data networks. In some embodiments network 212 can also include a voice network, such as a telephone network.

Contractor 202 includes a contractor server 214, which in one embodiment can be a server located at the contractor's physical location but in another embodiment can be a cloud server provided by a cloud service provider such as Amazon Web Services, Microsoft Azure, Google Cloud, etc. Among other things, server 214 can run or execute various software modules including customer relations management (CRM) module 216, scheduling and dispatch module 218, and one or more miscellaneous other modules 219 that, for instance, can perform functions that enable or support other modules. The modules within server 214 can interact with each other, and with modules on other servers for instance through application program interfaces (APIs). The server also includes network communication module 220, which communicatively couples server 214 to network 212 and manages communication between modules running on server 214 and network 212. Modules running on server 214 can also exchange data with—i.e., retrieve data from and write data to—databases 222. The illustrated embodiment has two databases 222a and 222b, but other embodiments can include more or less databases than shown. And, although illustrated as devices separate from the server, in other embodiments the databases can be part of the server itself—e.g., stored on a hard drive within the server.

Estimator 204 includes an estimator server 224, which in one embodiment can be a server located at the estimator's physical location but in another embodiment can be a cloud server provided by a cloud services provider such as Amazon Web Services, Microsoft Azure, Google Cloud, etc. Estimator server 224 can run or execute various software modules, including an AI prompt generator 226 and one or more miscellaneous modules 227 that, for instance, can perform functions that enable or support other modules on the server. The modules within server 224 can interact with each other, and with modules on other servers for instance through application program interfaces (APIs). The server also includes network communication module 228, which communicatively couples server 224 to network 212 and manages communication between modules running on the server and network 212. Through application programming interfaces (APIs), AI prompt generator 226 can, via network 212, present itself to modules running on contractor server 214, thus allowing modules such as CRM module 216 and scheduling/dispatch module 218 to interact with—e.g., exchange data, commands, or other information—with the AI prompt generator. In one embodiment the interaction between modules on contractor server 214 and modules on estimator server 224 can be bi-directional, meaning that each can send data, commands, or information to the other. But in other embodiments the interaction between modules can be unidirectional. Modules running on estimator server 224 can also exchange data with—i.e., retrieve data from and write data to—databases 230. In one embodiment, databases 230 can store information useful for AI prompt generator 226. The illustrated embodiment has two databases 230a and 230b, but other embodiments can include more or less databases than shown. And although databases 230 are illustrated as devices physically separate from the server, in other embodiments the databases can be part of the server itself.

AI provider 206 includes an AI provider server 232, which in one embodiment can be a server located at the AI provider's physical location but in another embodiment can be a cloud server provided by a cloud services provider such as Amazon Web Services, Microsoft Azure, Google Cloud, etc. AI provider server 232 can run or execute various software modules, including an AI engine 234 and one or more miscellaneous modules 235 that, for instance, can perform functions that enable or support the other modules on server 232. The modules within server 232 can interact with each other, and with modules on other servers for instance through application program interfaces (APIs). The AI provider server also includes network communication module 236, which communicatively couples server 232 to network 212 and manages communication between modules running on the server and network 212. Through APIs, AI engine 226 can also, via network 212, present itself to modules on contractor server 214, estimator server 224, or third-party server 240, thus allowing AI engine 234 to interact with—e.g., exchange data, commands, or other information—with AI prompt generator 226. In one embodiment the interaction between modules on the contractor server and modules on the estimator server can be bi-directional, meaning that each can send data, commands, or information to the other. But in other embodiments the interaction between modules on the different servers can be unidirectional.

Modules running on AI provider server 232 can also exchange data with—i.e., retrieve data from and write data to—AI databases 238. In one embodiment, databases 238 can store information that supports operation of AI engine 234, such as data, schema, or other data or data structures learned from training the AI engine on data obtained from sources such as the contractor, estimator, or third-party servers. The illustrated embodiment has two databases 238a and 238b, but other embodiments can include more or less databases than shown. And, although illustrated as devices separate from the server, in other embodiments the databases can be part of the server itself —e.g., stored on a hard drive within the server. In some embodiments AI provider 206 can be a commercially-available large-language model (LLM) AI service, such as Anthropic Systems' Claude, Microsoft Copilot, Google Gemini, Open AI Chat GPT, etc., but other embodiments can use other types of AI services.

Third party 210 is shown in the drawing as a single entity, but embodiments of system 200 can include multiple third parties. Inclusion of third parties in system 200 is optional; in some embodiments the third parties need not be included. When present, third parties 210 can include, for instance, sources of information relevant to contracting jobs. Examples of third parties include, without limitation, hardware manufacturers and retailers (e.g., inventory, pricing, scheduling information, product information, etc.), publishers or other contractors (e.g., instructions, suggestions, and how-to information for a given type of repair or installation), and data aggregators (e.g., an aggregator that collects price and inventory information from multiple retailers or wholesalers for comparison purposes).

Each third party 210 includes a third party server 240, which in one embodiment can be a server located at the third party's physical location but in another embodiment can be a cloud server provided by a cloud services provider such as Amazon Web Services, Microsoft Azure, Google Cloud, etc. Third party server 240 can run or execute various software modules. For instance, in an embodiment of system 200 with a third party 210 that is a hardware retailer, server 240 can execute a module 242 that provides pricing and inventory information. The third party server also includes network communication module 244, which communicatively couples server 240 to network 212 and manages communication between modules running on the server and network 212.

Through application programming interfaces (APIs), modules running in other parts of system 200 (e.g., CRM module 216, scheduling and dispatch module 218, AI prompt generator 226, and AI engine 234) can interact with—e.g., exchange data, commands, or other information—with third-party module 242. In one embodiment the interaction between modules on a third-party server and modules on other servers in system 200 can be bi-directional, meaning that each can send data, commands, or information to the other. But in other embodiments the interaction between modules on the different servers can be unidirectional. Modules running on a third-party server 240 can also exchange data with—i.e., retrieve data from and write data to—databases 246. In one embodiment, databases 246 can store information that supports operation of module 242, such as pricing data, inventory data, order data, manufacturer data, etc. The illustrated embodiment has two databases 246a and 246b, but other embodiments can include more or less databases than shown. And, although illustrated as devices separate from the server, in other embodiments the databases can be part of the server itself—e.g., stored on a hard drive within the server.

At job site 208, the customer can contact contractor 202 using a device 250, which in one embodiment can be a mobile device such as a phone or tablet, but in other embodiments it can be a different device such as a landline telephone, a laptop computer, or a desktop computer. In response, contractor 202 dispatches a technician dispatched to visit the job site and examine and assess problem 248. The technician can then use device 252 to communicate information to contractor 202, estimator 204, and so on. In one embodiment computing device 252 can be a mobile device such as a phone or tablet, but in other embodiments it can be a different device such as a laptop or desktop computer. The technician, in addition to speaking to the customer directly while at the job site, can use their device 252 to communicate with the customer's device 250 through network 212.

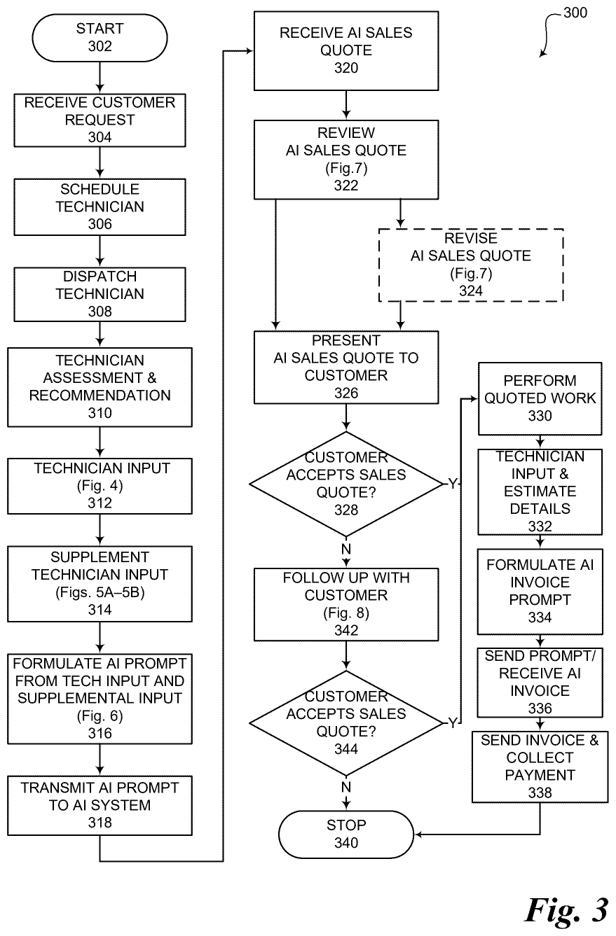

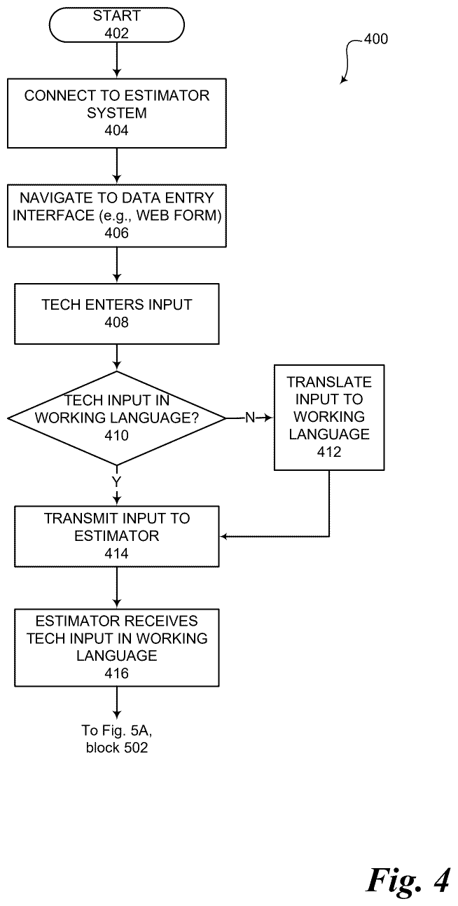

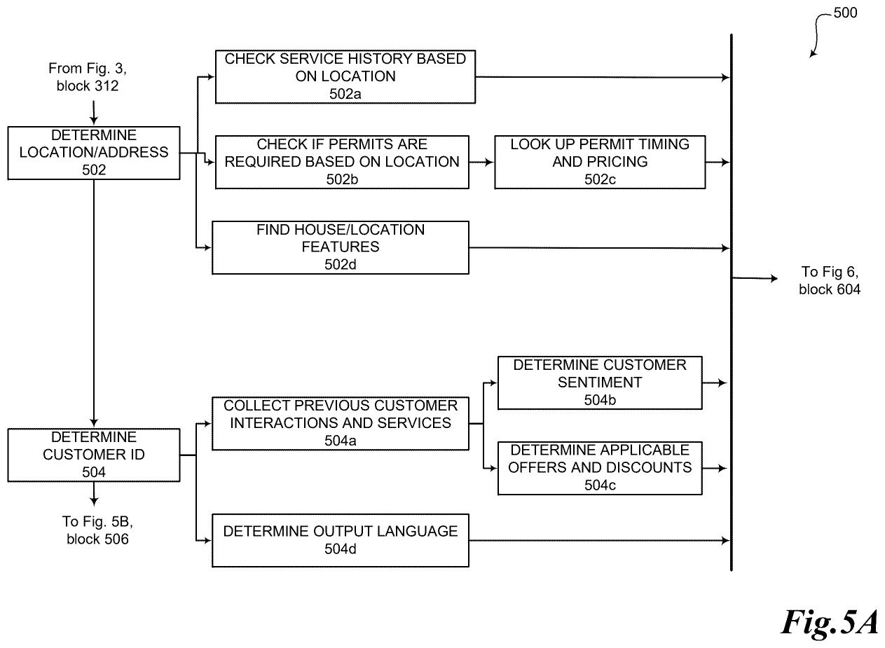

FIG. 3 illustrates, in flowchart form, an embodiment of a process 300 by which a contractor can use system 200 to create AI-enhanced sales quotes and provide them to a customer. The overall process is discussed in this figure and details of parts of the process are described below in connection with subsequent figures. Although the process is discussed below with reference to system 200, the same process can also be used with other system embodiments. In one embodiment of process 300, all data, whether in transit or at rest, is encrypted. But in other embodiment not all data need be encrypted: in some embodiments only some of the data can be encrypted, and in still other embodiments none of the data need be encrypted.

The process starts at block 302. At block 304, contractor 202 receives a request from customer 208 to visit the customer and provide a sales quote or work proposal for a job the customer wants done. At block 306, the contractor uses scheduling and dispatch module 218 to schedule a date and time for a technician to visit the customer's job site to assess the work the customer's needs. At block 308, at the date and time arranged at block 306, scheduling and dispatch module 218 dispatches a technician to the customers jobsite 208 to conduct the assessment and gather information needed for a sales quote.

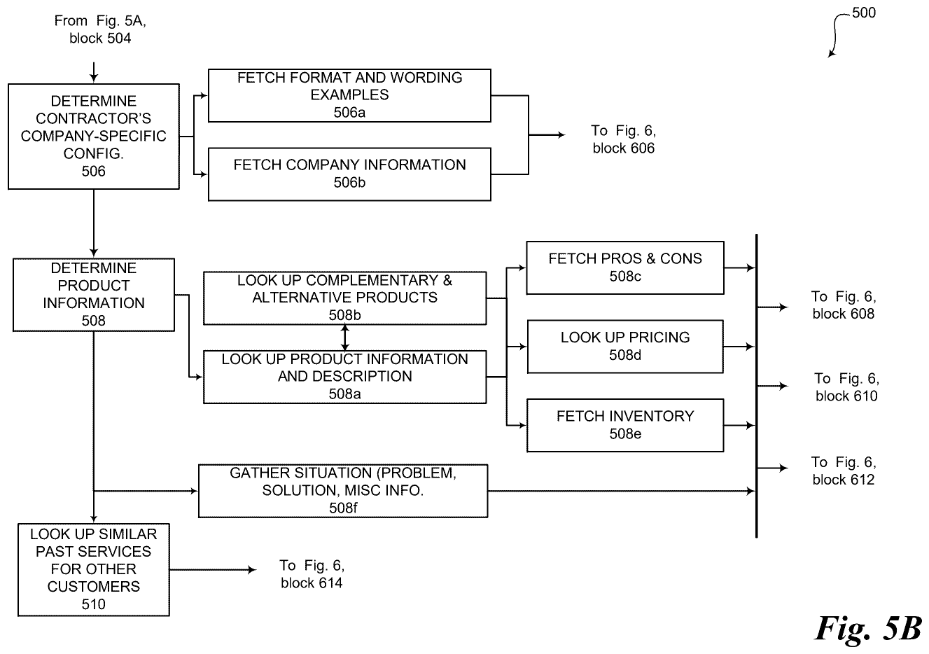

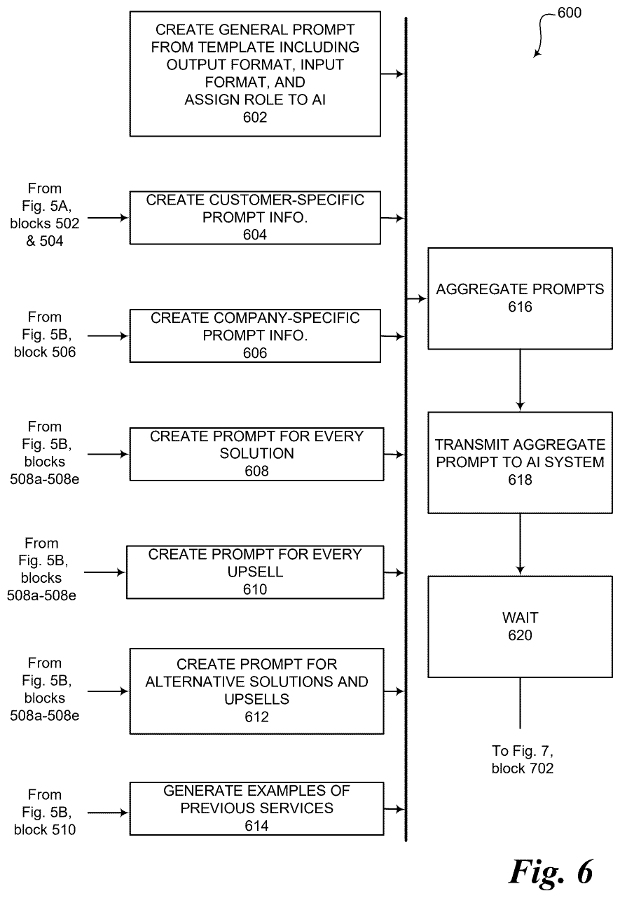

At block 310 the technician inspects the situation, determines the problem to be solved, and comes up with an initial recommendation. At this stage, the initial recommendation might or might not be shared with the customer. At block 312, the technician uses their device 252 to input information about the situation (see FIG. 4). At block 314, AI prompt generator 226 queries CRM module 216, scheduling and dispatch module 218, and possibly other modules or data sources, to obtain supplemental input to supplement the technician's input (see FIGS. 5A-5B).

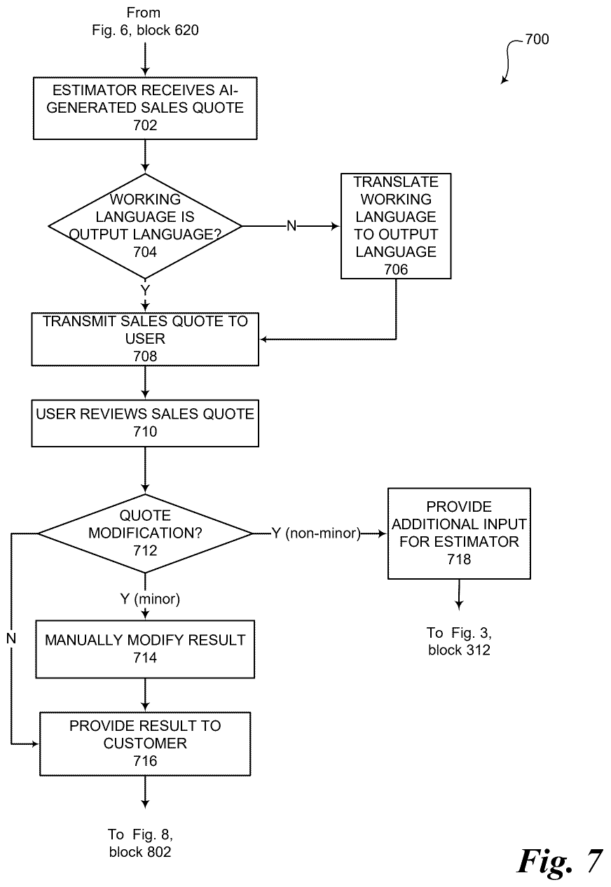

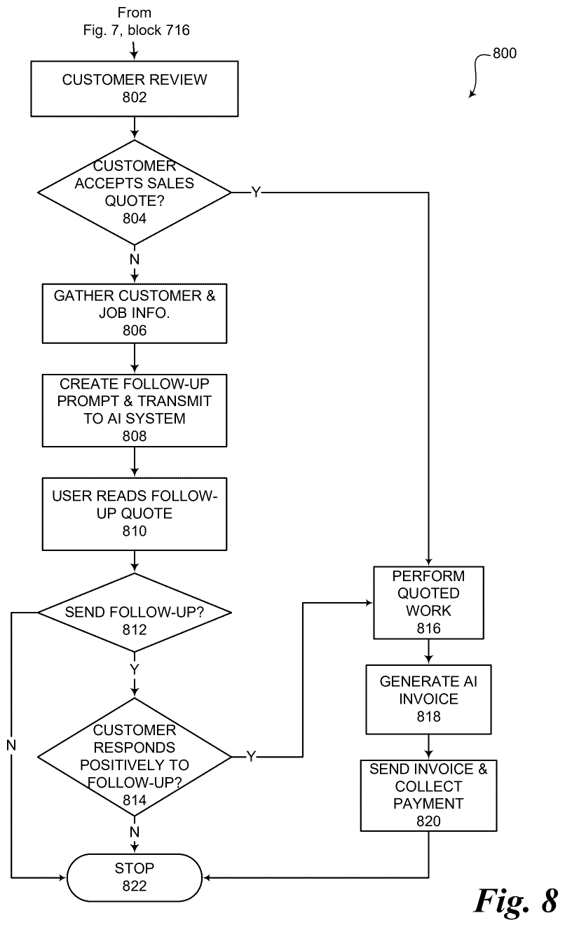

At block 316, AI prompt generator 226 uses the technician input from process 400 and the supplemental input from process 500 to assemble an aggregate AI prompt (see FIG. 6), and at block 318 the aggregate prompt is transmitted to AI engine 234 for processing into a sales quote. At block 320 contractor 202 and the technician receive the AI-enhanced sales quote and, following receipt by the technician, at block 322 the contractor and/or the technician review the AI sales quote. If the AI sales quote requires no revision, the technician can present the AI sales quote to the customer at block 326. But if the AI sales quote requires or would benefit from revision, the technician can revise the AI sales quote at block 324 and then present it to the customer at block 326. In one embodiment the AI sales quote can be presented to the customer electronically through customer device 250, for instance as an e-mail, an e-mail attachment, or a hyperlink. In other embodiments the technician can present the AI sales quote to the customer differently, for instance as hardcopy printed on paper. The review, possible revision, and customer presentation in blocks 322-326 is described in more detail below in connection with FIG. 7.

After the AI sales quote is presented to the customer at block 326, and the customer has reviewed and considered it, at block 328 the customer decides whether to accept the sales quote—i.e., whether to engage the contractor to provide the products and services. If at block 328 the customer accepts the AI sales quote, then at block 330 the contractor provides the products and performs the work described in the sales quote. When the products and work described in the sales quote have been performed at block 330, the process advances to block 332, where it collects details from the original estimate and also collects post-work input from the technician. Post-work input from the technician can include general comments about the work, areas where the work or the products varied from the initial estimate, areas where the work ended up over or under the estimated amount, and so on. In an embodiment, the AI generated invoice can also have a dynamic prompt depending on factors like is a warranty call, did the sale go through, is this summarizing estimates, etc.

At block 334, the process uses the information collected at block 332 to generate an AI invoice prompt, and at block 336 it sends the prompt to AI engine 234 and receives the AI-generated invoice. At block 338 the contractor sends the AI-generated invoice to the customer and collects payment for the products provided and work performed, and at block 340 the process ends. But if at block 328 the customer does not accept the AI sales quote, then at block 342 the contractor can follow up with the customer (see FIG. 8). The process then advances to block 344, where it checks whether, after the follow-up, the customer accepts the AI sales quote. If at block 344 the customer accepts the sales quote, the process moves to block 330 and proceeds as described above, otherwise the process stops at block 340.

FIG. 4 illustrates, in flowchart form, an embodiment of a process 400 for technician input. Process 400 occurs within block 312 of FIG. 3. In one embodiment process 400 can be performed primarily by a module running in estimator server 224, such as AI prompt generator 226, or a module running on contractor server 214, such as scheduling and dispatch module 218.

The process starts at block 402. At block 404, the technician uses their device 252 to connect to estimator server 224 through network 212. In one embodiment, the technician can log into estimator server 224 and AI prompt generator 226 through a module running on contractor server 214, such as scheduling and dispatch module 218. The scheduling and dispatch module can maintain a unique job ID for every scheduled job and can use the job ID to retrieve further information about a job. In another embodiment, estimator 204 maintains an account for contractor 202 so that the technician, as an employee of the contractor, can log directly into the contractor's estimator account, manually or automatically. Either method of logging in allows the estimator to identify the contractor, so that modules running on estimator server 224 can, via the relevant APIs and job ID, begin interacting with modules running on contractor server 214.

Having connected to the estimator server at block 404, at block 406, the technician can navigate, or upon login can be automatically taken to, a data entry interface. In one embodiment, the data entry interface can be a web form accessed using a web browser running on the technician's device, but other embodiments can use other types of data entry interfaces.

At block 408, the technician enters relevant information into the data entry interface. In one embodiment, the data entry interface can be structured to include questions for the technician and fields for the technician's answers, but in other embodiments the data entry interface can support more free-form technician input. The relevant information entered at block 408 can include information about the customer and the problem. In one embodiment, relevant information can include, without limitation:
Customer information including name, contact information, and service address. This information can be entered manually by the technician or obtained from the scheduling and dispatch module 218 or CRM module 216 on the contractor server.
How old the customer's house or facility is.
A description of the problem.
A recommended solution to the problem.
Any upsells spotted by the technician. Upsells are additional problems or issues spotted by the technician in addition to the problem or issue reported by the customer. The upsell can be related or unrelated to the reported issue.
Consequences of failing to solve the problem.
The output language to be used. For instance, if the technician and the customer speak Spanish, the technician might request that the output—that is, the sales quote—be in Spanish. The output language can also be detected automatically based on the technician's input; if the technician enters the information in Spanish, for instance, the system can assume that the output must also be in Spanish.

Having entered the relevant information at block 408, at block 410 the process checks whether the input language is the same as the system's working language. For instance, even if the input is in Spanish, the system's working language—the language in which it conducts its operations—might be English. If at block 410 the input language is the same as the working language, then the process advances directly to block 414. But if at block 410 the input language is different from the working language, then the process goes to block 412, where it translates the input into the working language. The translation can be done by AI engine 234, an AI engine different than AI engine 234, or a translation module running on contractor server 214, estimator server 224, or a third party server 240. When the translation is complete, the process advances to block 414, where it transmits the working-language input to AI prompt generator 226 on estimator server 224. At block 416, AI prompt generator 226 receives the input information and the process advances to FIG. 5A, block 502.

FIGS. 5A-5B together illustrate, in flowchart form, an embodiment of a process 500 for obtaining supplemental input to supplement the technician input from process 400. Process 500 occurs within block 314 of process 300 (see FIG. 3) and in one embodiment of system 200 can be performed a module running in estimator server 224, such as AI prompt generator 226, together with a module running in contractor server 214, such as scheduling and dispatch module 218 and CRM module 216. Process 500 includes operations shown in blocks 502-508, each of which has one or more associated follow-on operations. In one embodiment operations 502-508 and their follow-on operations can be performed in the order shown, but in other embodiments they can be performed in a different order.

The process starts at block 502 after the technician completes the data input at block 312 (see FIG. 3). At block 502, the process determines the location or address of the customer's house or facility, which it can extract from scheduling and dispatch module 218 or, if the customer is an existing customer, from CRM module 216. Using the information obtained at block 502, in follow-on blocks 502a-502d the process checks for location-specific information and collects it if available. At block 502a, the process checks whether the customer's property has an established service history with the contractor. This information can be extracted from CRM module 216 in one embodiment. At block 502b the process checks whether permits are required for the proposed work and, if permits are required, then at block 502c the process can look up permit pricing (how much they cost) and timing (how long they take to get). In one embodiment, the information for blocks 502b-502c can be obtained from recent data for similar jobs stored in the contractor's databases, but in other embodiment it can be obtained from other third-party sources. Permit information, for instance, can be looked up from a local government website. At block 502d the process looks up features of the house or location. In one embodiment, the information for block 502d can be obtained from recent data for similar jobs stored in the contractor's databases, but in other embodiment it can be obtained from other third-party sources, such as a local government website or a real-estate website (e.g., Zillow.com).

At block 504, the process determines the customer ID, which it can extract from scheduling and dispatch module 218 or, if the customer is an existing customer, from CRM module 216. Using the information obtained at block 504, in follow-on blocks 504a-504d the process looks up customer-specific information and collects it if available. At block 504a, the process checks whether the customer has an established history of interactions with, or products or services provided by, the contractor. This information can be extracted from CRM module 216 in one embodiment.

At block 504b the process determines the customer's sentiment based on previous interactions found at block 504a. The customer's sentiment can include information such as which products and services they chose, what their price point or budget was for the previous products and services, whether they were happy with the provided products and services, etc. At block 504c, the process determines whether any discounts or special offers apply to products or services that would solve the customer's problem, including any upsells, as identified by the technician's input. In one embodiment, the information for block 504b can be obtained from recent data for similar jobs stored in the contractor's databases, and the information for block 504c can be obtained from a product and service database accessible to the contractor or from the websites of third parties such as a construction product retailer or wholesaler or an aggregator of such information. At block 504d the process determines the output language of the AI sales quote, which can be the same or different than the system's working language. At the conclusion of all follow-on blocks associated with block 504, the process advances to block 506 (see FIG. 5B).

At block 506, the process determines contractor-specific information to be used in the AI sales quote. At block 506a, the process looks up format and wording examples from some of the contractor's previous sales quotes, so that the appearance of the AI sales quote, and terminology used in the AI sales quote, will be the same or similar to previous quotes from the same contractor. This information can be looked up in the contractor's CRM module 216 in one embodiment. At block 506b the process determines the contractor's company information. In some embodiments this can include its address, contractor license number, payment information (bank routing number, account number, etc.), credit card payment information, and so on. At the conclusion of all follow-on blocks associated with block 506, the process advances to block 508.

At block 508, the process determines product information for products that will be included in the AI sales quote. In various embodiment, the information for block 508 and its follow-on blocks 508a-508f can be looked up from recent data for similar jobs stored in the contractor's databases, from a product and service database accessible to the contractor, from the websites of third parties such as construction product retailers or wholesalers, from an aggregator of such information, from product-review sites, or from other sources not listed here.

At block 508a the process identifies and looks up descriptions and information for products that can be used for the recommended repair, and any upsells, and at block 508b it looks up descriptions and information for alternative or complementary products. At block 508c it looks up pros and cons of each product identified in blocks 508a-508b, at block 508d it looks up pricing for these products, and at block 508e it looks up inventory information for the products. At block 508f, the process looks up and gathers situation information, including for instance information about the identified problems and upsells, information about previous solutions (e.g., how to implement them, how successful they were). Finally, at block 510 the process can look up information for similar services performed for the contractor's other customers.

At the conclusion of each block 502-508 and its follow-on blocks, or at the end of process 500, the information looked up and collected in blocks 502-508 and their follow-on blocks can be transferred to the prompt assembly process carried out by AI prompt generator 226, as shown in FIG. 6. More specifically, in the illustrated embodiment:
information looked up at block 502 and its follow-on blocks 502a-502c is transferred to process 600 at block 604;
information looked up at block 504 and its follow-on blocks 504a-504d is transferred to process 600 at block 604;
information looked up at block 506 and its follow-on blocks 506a-506b is transferred to process 600 at block 606;
information looked up at block 508 and its follow-on blocks 508a-508e is transferred to process 600 at blocks 608, 610, and 612; and
information looked up at block 510 is transferred to process 600 at block 614.

FIG. 6 illustrates, in flowchart form, an embodiment of a process 600 for assembling an aggregate AI prompt using the technician input from process 400 and the supplemental input from process 500. Process 600 occurs within block 316 of process 300 (see FIG. 3) and, in system 200, is carried out by AI prompt generator 226.

The process starts at block 602, which creates a general prompt from a template. The template can include an input format, and output format, and can also assign a role to the AI system that will be used. Following block 602, at blocks 604-614 the process creates a number of constituent prompts. At block 604, the process uses information received from blocks 502 and 504 to create customer-specific prompt information. At block 606, the process uses information received from block 506 to create company-specific (i.e., contractor-specific) prompt information. Following block 606, blocks 608-612 use information received from blocks 508a-508e as follows: block 608 creates a prompt for every identified solution; block 610 creates a prompt for every potential upsell; and block 612 creates a prompt for alternative solutions and upsells. Finally, block 614 uses information received from block 510 to generate examples of previous services provided by the contractor.

Having generated constituent prompts at each of blocks 602-614, the process advances to block 616, where it aggregates the constituent prompts. In one embodiment block 616 uses input from all of blocks 604-614, but in other embodiments it need not have input from all these blocks and can generate an aggregate prompt using information from fewer than all blocks. In one embodiment, block 616 creates an aggregate AI prompt by simply concatenating the constituent prompts, but in other embodiments an aggregate AI prompt can be created differently. An embodiment of a simple concatenated AI prompt is as follows:
An electrical company known as <XYZ ELECTRICAL>, sends technicians to assess customer issues on site. Convert the survey below into an estimate. Do not use phrases <ABC, DEF, GHI>. \n A good estimate will go into detail about <X> things: the features and benefits of the solution, and a description of what happens if the solution is not fixed. Here's a good example of an estimate. <example> We found an issue with your sewer line. The existing 4-inch clay sewer pipe has multiple separations and breaks, causing sewage to leak into the ground and leading to blockages. If this issue is not addressed, the problem will persist and eventually result in a complete blockage.\n\n Our recommended solution is twofold:\n1. Dig a 4×2 foot open trench for 15 feet from the foundation of your home to the property line to fix the improper slope.\n2. Perform a Trenchless pull of 30 feet from the property line to the city connection in the street.\n For the open trench portion, we will use a 4-inch SDR-26 pipe, while the Trenchless section will utilize a 4-inch SDR-17 pipe.\n \n- The Trenchless method minimizes disruption to your landscaping by only requiring two holes at the beginning and end of the pipe, rather than exposing the entire section.\n- It connects your existing two-way clean out and city clean out to the new line.\n- The continuous stretch of pipe eliminates the risk of future root penetrations.\n\n\n If this issue is not addressed, the sewer line will continue to deteriorate, leading to potential ruptures, leaks, and even collapse. By addressing this issue now, you can avoid further complications and ensure a permanent solution to your plumbing problems. \n\n If you have any additional questions or would like to discuss scheduling or financing options, please call XYZ ELECTRICAL at xxx-xxx-xxxx. </example>
Write Y sales estimates. Please provide a sales estimate for each solution.
Write the estimate with an audience of XYZ.
The first solution is the most recommended solution while the next solution is the alternative solution
<survey>
{Aggregated problem statement, issues, list of feedback, etc . . . }.
Example:
What is the problem?
Do you have any additional notes or comments?
Company Name: XYZ ELECTRICAL
Company Phone Number: xxx-xxx-xxxx
</survey>
<estimate>
{AGGREGATED ESTIMATE REQUIREMENTS}
</estimate>
The response is to be in JSON format with the format of {. . . }.
   Ensure that newlines are escaped with a single backslash.

To reduce the occurrence of AI hallucinations, embodiments of the aggregation process at block 616 can include chaining of large-language model (LLM) inputs/outputs—e.g., output from one LLM run becomes input to another LLM run. This can help increase accuracy of the LLM output by breaking down the big problem into smaller problems and can also improves the AI response time by executing multiple LLMs in parallel. For example, one embodiment can concurrently run LLMs for each input question then aggregate output into the final step. In some embodiments other guardrails to verify the AI is not hallucinating can be added after the final output, and the estimate is re-processed if hallucination is detected. An embodiment of a guardrail is described below in connection with FIG. 7.

Having completed the aggregate AI prompt at block 616 the process advances to block 618, where it transmits the aggregate AI prompt to AI engine 234 for processing, and then proceeds to block 620 where it waits for an AI-generated sales quote to be returned by AI engine 234.

FIG. 7 illustrates, in flowchart form, an embodiment of a process 700 for a user (e.g., a technician) to review and revise an AI sales quote generated by AI engine 234. Process 700 occurs within block 312 of FIG. 3 and, in system 200, can be carried out by a module running on estimator server 224 or contractor server 214, as well as by modules running on technician device 252.

The process starts at block 702, where estimator server 224 receives the AI sales quote. The AI sales quote will, at least initially, be in the working language, so at block 704 the process checks whether the desired output language of the AI sales quote is the same as the working language. If at block 704 the output language is the same as the working language, the process moves to block 708 where the AI sales quote is transmitted to the user (e.g., the contractor and/or technician). But if at block 704 the output language is different from the working language the process moves to block 706, where it translates the AI sales quote from the working language to the output language. As in the translation of the technician input at block 412 (see FIG. 4), the translation can be done by AI engine 234, an AI engine different than AI engine 234, or a translation module running on contractor server 214, estimator server 224, or third party server 240.

After translation from working language to output language, the process moves to block 708 when the AI sales quote is transmitted to the user, which can be contractor 202, the technician, or both. At contractor server 214, the AI sales quote can be input or “pushed back” into CRM module 216 or scheduling and dispatch module 218, so that it can be associated with the particular job ID or customer ID and can be stored in associated databases. The AI sales quote can be reviewed by someone at contractor 202, by the technician, or both. At block 710 the AI sales quote is reviewed and at block 712 the reviewer or reviewers decide whether to modify it before delivering it to the customer.

If at block 712 there are no modifications for the AI sales quote, then the process advances to block 716 and the AI sales quote is delivered to the customer. But if at block 712 there are modifications to the AI sales quote, then there are two modification paths depending, among other things, on the extent of the modifications. If only minor modifications are needed or wanted, the process moves to block 714, where the AI sales quote itself can be manually modified by a user. But if at block 712 more extensive modifications are needed—e.g., modifications that require another pass through AI engine 234—then the process moves to block 718, where the user can provide additional input, substantially as shown in block 312 of process 300 (see FIG. 3), an embodiment of which is described in more detail in process 400 (FIG. 4). For instance, on occasion AI systems can “hallucinate,” providing incorrect or irrelevant information in response to a prompt. If this happens in an AI sales quote, at block 718 the user can provide additional information that might help the AI system resolve the hallucination. To give a more specific example, if the initial technician input refers to an air purifier, the AI engine might confuse the air purifier with an air humidifier and return an incorrect and irrelevant result. At block 718 the user can help cure the problem by providing more information about air purifiers, such as adding a sentence indicating that a purifier is used to purify, not humidify, ambient air. After block 718 the process again goes through the parts of process 300 following block 312 until it delivers a revised AI sales quote that takes into consideration the additional information provided at block 718.

FIG. 8 illustrates, in flowchart form, an embodiment of a process 800 for customer follow-up. Process 800 is a process that occurs within block 334 of process 300 (see FIG. 3). The process starts at block 802, where the customer reviews and considers the AI sales quote after receiving it from the technician or contractor at block 716 in process 700 (see FIG. 7). At block 804 the customer decides whether to accept the sales quote-that is, whether to engage the contractor to deliver the products, and perform the services, described in the AI sales quote. If at block 804 the customer accepts the AI sales quote, then at block 816 the contractor provides the products and performs the work described. At block 818 the contractor bills and collects payment for the products provided and work performed, and at block 820 the process ends.

But if at block 804 the customer does not accept the AI sales quote, then the user (e.g., the contractor or technician) can follow up with the customer, immediately or after a delay. At block 808 the process gathers customer and job information from the previous AI sales quote; in one embodiment this information can be obtained from CRM module 216 or scheduling and dispatch module 218. At block 810, the process, using the information from block 808, creates a follow-up prompt and transmits the follow-up prompt to AI provider 206 so that AI engine 234 can create a follow-up AI sales quote.

At block 810, after receiving the follow-up AI sales quote from the AI provider, the user reviews it and at block 812 the user decides whether to send it. If at block 812 the user decides not to send the follow-up AI sales quote, then the process advances to block 822 and stops. But if at block 812 the user decides to send the follow-up sales quote, then it is sent to the customer. At block 814 the process checks whether the customer responds positively to the follow-up AI sales quote (e.g., if the client wants the contractor to provide the products and services based on the follow-up sales quote). If at block 814 the customer declines the follow-up sales quote, then the process advances to block 822 and stops. But if at block 814 the customer accepts the follow-on AI sales quote, then at block 816 the contractor provides the products and performs the work described in the sales quote. At block 818 the contractor prepares an AI-generated invoice for the products provided and work performed; an embodiment of a process for preparing an AI-generated invoice is described above and shown in FIG. 3, blocks 332-334. At block 820, the user sends the AI-generated invoice to the customer and collects payment, and at block 822 the process ends.

The above description of embodiments is not intended to be exhaustive or to limit the invention to the described forms. Specific embodiments of, and examples for, the invention are described herein for illustrative purposes, but various modifications are possible.

What is claimed is:

1. An apparatus comprising:
a server communicatively coupled to a network;
at least one software module running on the server, the at least one software module including instructions that, when executed by the server, cause the server to:
receive input information input by a technician into a technician device communicatively coupled to the network, the input information being relevant to a product or a service that the technician has identified to solve a problem presented to the technician by a customer,
look up supplemental information about the problem, the product, or the service, and
aggregate the input information and the supplemental information into an aggregated artificial intelligence (AI) prompt.

2. The apparatus of claim 1 wherein the at least one software module further includes instructions that, when executed by the server, cause the server to:
transmit the aggregated AI prompt to an AI engine to generate an AI sales quote; and
receive the AI sales quote from the AI engine.

3. The apparatus of claim 2 wherein the at least one software module further includes instructions that, when executed by the server, cause the server to:
transmit the AI sales quote to the technician device or to a contractor device of a contractor with whom the technician is associated; and
modify the AI sales quote in response to further input from the contractor or the technician.

4. The apparatus of claim 3 wherein:
if the modification of the AI sales quote is minor, then the AI sales quote is modified by adding, deleting, or revising information in the AI sales quote based on the further input; and
if the modification of the AI sales quote is not minor, then the AI sales quote is modified by modifying the aggregated AI prompt based on the further input and re-submitting the modified aggregated AI prompt to the AI engine.

5. The apparatus of claim 3 wherein the at least one software module further includes instructions that, when executed by the server, cause the server to transmit the AI sales quote to the customer.

6. The apparatus of claim 5 wherein the AI sales quote is transmitted to the customer through a customer device communicatively coupled to the network.

7. The apparatus of claim 5 wherein the at least one software module further includes instructions that, when executed by the server, cause the server to:
generate a follow-up AI prompt based on the AI sales quote;
transmit the follow-up AI prompt to the AI engine to generate a follow-up AI sales quote; and
receive the follow-up AI sales quote.

8. The apparatus of claim 7 wherein the at least one software module further includes instructions that, when executed by the server, cause the server to:
transmit the follow-up AI sales quote to the technician device or to a contractor device of a contractor with whom the technician is associated; and
transmit the follow-up AI sales quote to the customer in response to input from the contractor or the technician.

9. The apparatus of claim 1 wherein the at least one software module receives the input information and looks up the supplemental information through one or more application programming interfaces.

10. The apparatus of claim 9 wherein looking up supplemental information includes looking up information stored on the server, and looking up information stored on another server, or both.

11. The apparatus of claim 1 wherein aggregating the input information and the supplemental information into an aggregated AI prompt comprises:
generating one or more AI prompts based on the input information;
generating one or more AI prompts based on the supplemental information; and
concatenating the AI prompts based on the input information with the AI prompts based on the supplemental information.

12. The apparatus of claim 1 wherein the supplemental information includes information about the desired format and wording of the AI sales quote.

13. A system comprising:
an estimator server communicatively coupled to a network;
at least one software module running on the estimator server, the at least one software module including one or more application programming interfaces that allow the estimator server to interact via the network with a contractor server and an artificial intelligence (AI) server, the at least one software module including instructions that, when executed by the estimator server, cause the estimator server to:
receive input information input by a technician into a technician device communicatively coupled to the network, the input information being relevant to a product or a service that the technician has identified to solve a problem presented to the technician by a customer,
look up supplemental information about the problem, the product, or the service,
aggregate the input information and the supplemental information into an aggregated artificial intelligence (AI) prompt,
transmit the aggregated AI prompt to an AI engine on the AI server for processing into an AI sales quote, and
receive the AI sales quote and transmit it to the contractor server.

14. The system of claim 13 wherein the aggregated AI prompt is transmitted via one of the one or more APIs to the AI engine.

15. The system of claim 13 wherein the at least one software module further includes instructions that, when executed by the estimator server, cause the estimator server to:
transmit the AI sales quote to the technician device or to the contractor server; and
modify the AI sales quote in response to further input received from the contractor server or the technician device.

16. The system of claim 15 wherein:
if the modification of the AI sales quote is minor, then the AI sales quote is modified by adding, deleting, or revising information in the AI sales quote based on the further input; and
if the modification of the AI sales quote is not minor, then the AI sales quote is modified by modifying the aggregated AI prompt based on the further input and re-submitting the modified aggregated AI prompt to the AI engine.

17. The system of claim 16 wherein the at least one software module further includes instructions that, when executed by the estimator server, cause the estimator server to transmit the AI sales quote to the customer.

18. The system of claim 17 wherein the AI sales quote is transmitted to the customer through a customer device communicatively coupled to the network.

19. The system of claim 17 wherein the at least one software module further includes instructions that, when executed by the server, cause the server to:
generate a follow-up AI prompt based on the AI sales quote;
transmit the follow-up AI prompt to the AI engine to generate a follow-up AI sales quote; and
receive the follow-up AI sales quote.

20. The system of claim 19 wherein the at least one software module further includes instructions that, when executed by the server, cause the server to:
transmit the follow-up AI sales quote to the technician device or to the contractor server; and
transmit the follow-up AI sales quote to the customer in response to input from the contractor server or the technician device.

21. The system of claim 13 wherein the at least one software module receives the input information and looks up the supplemental information using one of the one or more APIs.

22. The system of claim 21 wherein looking up supplemental information includes looking up information stored on the contractor server, looking up information stored on another server, or both.

23. The system of claim 13 wherein aggregating the input information and the supplemental information into an aggregated AI prompt comprises:
generating one or more AI prompts based on the input information;
generating one or more AI prompts based on the supplemental information; and
concatenating the AI prompts based on the input information with the AI prompts based on the supplemental information.

24. The system of claim 13 wherein the supplemental information includes information about the desired format and wording of the AI sales quote.
